(19) United States
(12) Patent Application Publication
(10) Pub. No.: US 2025/0103422 A1
(43) Pub. Date: Mar. 27, 2025

(54) INFORMATION PROCESSING DEVICE, INFORMATION PROCESSING METHOD, AND PROGRAM

(71) Applicant: NEC Corporation, Minato-ku, Tokyo (JP)

(72) Inventors: Keita SAKUMA, Tokyo (JP); Ryuta Matsuno, Tokyo (JP)

(73) Assignee: NEC Corporation, Minato-ku, Tokyo (JP)

(21) Appl. No.: 18/578,803

(22) PCT Filed: Aug. 23, 2023
(86) PCT No.: PCT/JP2023/030357

§ 371 Date: Jan. 12, 2024

(30) Foreign Application Priority Data
Feb. 28, 2023 (WO) PCT/JP2023/007228

(51) Int. Cl. G06F 11/07

(52) U.S. Cl. CPC G06F 11/079

(57) ABSTRACT

An information processing device 100 of the present disclosure can assist decision-making by a user by including: an error calculation unit 121 that calculates a prediction error which is a difference between a prediction value which is output obtained when an explanatory variable of subject data is input to a prediction model and an objective variable of the subject data; an index calculation unit 122 that calculates, on a basis of data that can be used for calculating the prediction error, an index for evaluating an amount of contribution of at least one of the explanatory variable of the subject data, the objective variable of the subject data, and the prediction model to the prediction error; and a contribution calculation unit 123 that calculates the amount of contribution on a basis of the prediction error and the index.

### TECHNICAL FIELD

The present disclosure relates to an information processing device, an information processing method, and a program.

### BACKGROUND ART

Prediction models generated by machine learning are operationally used to predict output obtained by inputting new data. On the other hand, during the operational use of the prediction models, prediction errors can occur due to various factors. In this case, analysis of the factors of the prediction errors is important for amelioration of the prediction models.

Here, a technology to analyze factors of prediction errors of a prediction model is disclosed in Patent Literature 1. According to Patent Literature 1, indices of an explanatory variable or an objective variable used in a prediction model are calculated to thereby specify factors of prediction errors. For example, according to Patent Literature 1, the abnormal degree of an explanatory variable is evaluated, or the distribution distances between training data and operational-use data are evaluated to thereby analyze factors that caused a prediction error.

### CITATION LIST

### Patent Literature

Patent Literature 1: WO 2022/180749

### SUMMARY OF INVENTION

### Technical Problem

However, according to the technology described in Patent Literature 1 described above, it is analyzed merely whether or not factors of prediction errors of the prediction model are attributable to samples, and the factors cannot be evaluated quantitatively. This can cause a disadvantage that it becomes difficult to examine appropriate measures for ameliorating a prediction model according to factors of prediction errors, and it is not possible to further improve the precision of the prediction model.

Because of this, an object of the present disclosure is to provide an information processing device that can solve the disadvantage described above that it is not possible to further improve the precision of a prediction model.

### Solution to Problem

An information processing device according to one aspect of the present disclosure includes:
an error calculation unit that calculates a prediction error which is a difference between a prediction value which is output obtained when an explanatory variable of subject data is input to a prediction model and an objective variable of the subject data;
an index calculation unit that calculates, on the basis of data that can be used for calculating the prediction error, an index for evaluating an amount of contribution of at least one of the explanatory variable of the subject data, the objective variable of the subject data, and the prediction model to the prediction error; and
a contribution calculation unit that calculates the amount of contribution on the basis of the prediction error and the index.

Further, an information processing method according to one aspect of the present disclosure includes:
calculating a prediction error which is a difference between a prediction value which is output obtained when an explanatory variable of subject data is input to a prediction model and an objective variable of the subject data;
calculating, on the basis of data that can be used for calculating the prediction error, an index for evaluating an amount of contribution of at least one of the explanatory variable of the subject data, the objective variable of the subject data, and the prediction model to the prediction error; and
calculating the amount of contribution on the basis of the prediction error and the index.

Further, a program according to one aspect of the present disclosure causes a computer to execute processes of:
calculating a prediction error which is a difference between a prediction value which is output obtained when an explanatory variable of subject data is input to a prediction model and an objective variable of the subject data;
calculating, on the basis of data that can be used for calculating the prediction error, an index for evaluating an amount of contribution of at least one of the explanatory variable of the subject data, the objective variable of the subject data, and the prediction model to the prediction error; and
calculating the amount of contribution on the basis of the prediction error and the index.

### Advantageous Effects of Invention

With the configuration described above, the present disclosure makes it possible to further improve the precision of a prediction model.

### BRIEF DESCRIPTION OF DRAWINGS

FIG. 1 is a figure for describing a function of an information processing device in a first exemplary embodiment of the present disclosure.

FIG. 2 is a block diagram illustrating the configuration of the information processing device in the first exemplary embodiment of the present disclosure.

FIG. 3 is a figure illustrating the content of a process performed by the information processing device disclosed in FIG. 2.

FIG. 4 is a flowchart illustrating an operation of the information processing device disclosed in FIG. 2.

FIG. 5 is a block diagram illustrating the configuration of the information processing device in a third exemplary embodiment of the present disclosure.

FIG. 6 is a figure illustrating the content of a process performed by the information processing device disclosed in FIG. 5.

FIG. 7 is a block diagram illustrating the hardware configuration of an information processing device in a fourth exemplary embodiment of the present disclosure.

FIG. 8 is a block diagram illustrating the configuration of the information processing device in the fourth exemplary embodiment of the present disclosure.

### DESCRIPTION OF EMBODIMENTS

### First Exemplary Embodiment

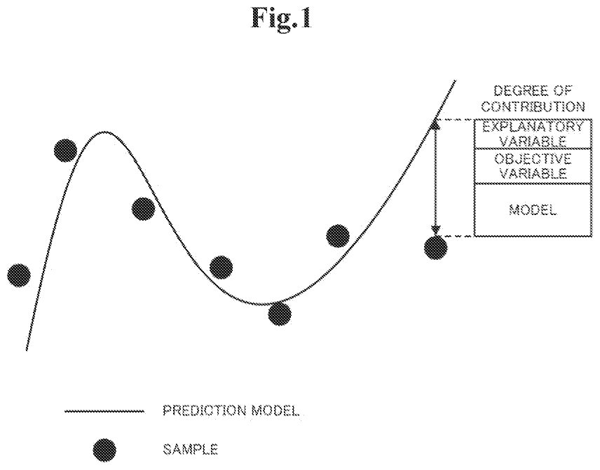

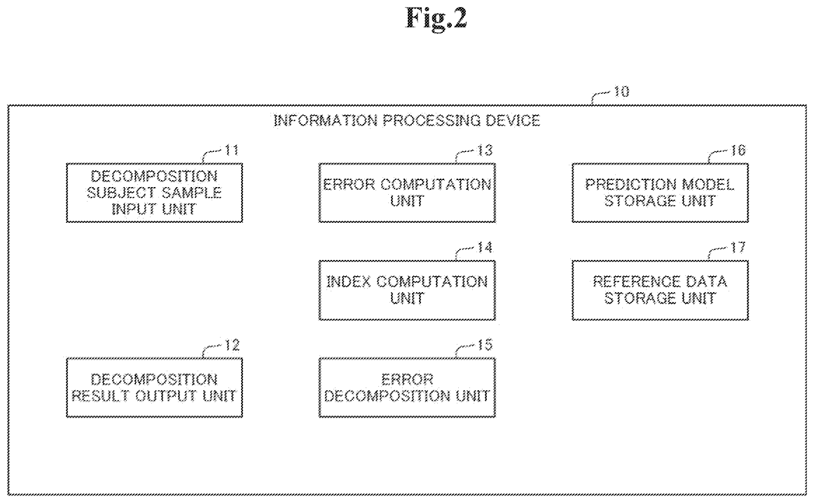

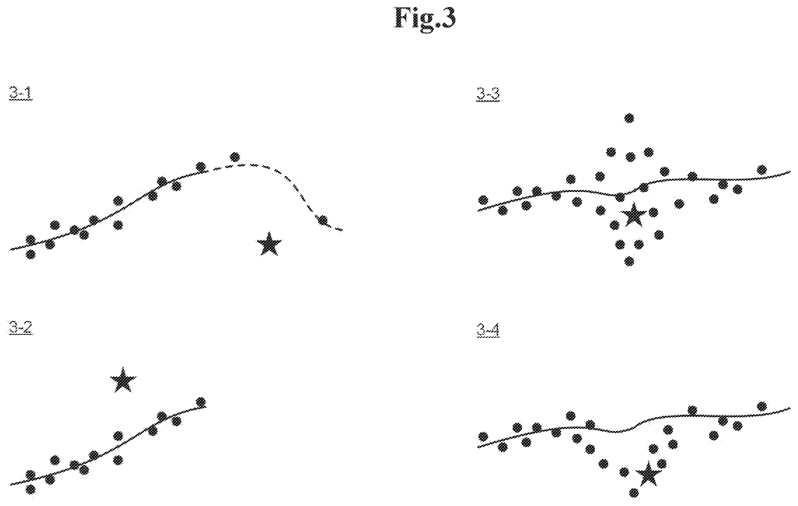

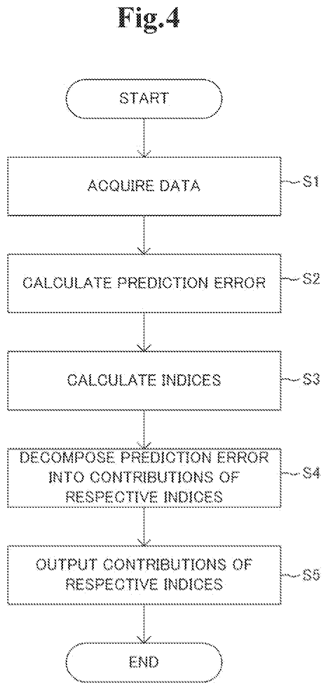

A first exemplary embodiment of the present disclosure will be described with reference to FIG. 1 to FIG. 4. FIG. 1 is a figure for describing a function of an information processing device. FIG. 2 is a figure for describing the configuration of the information processing device, and FIG. 3 to FIG. 4 are figures for describing a processing operation of the information processing device.

### [Configuration]

An information processing device 10 in the present embodiment quantitatively evaluates factors of a prediction error in a prediction model generated by machine learning. For example, it is supposed that, as represented by an arrow in FIG. 1, there is a prediction error of a prediction value which is output obtained when sample data is input to the prediction model. In this case, the information processing device 10 calculates amounts of contribution of respective pieces of data by decomposing factors of the prediction error. Note that, as illustrated in FIG. 1, in an example described in the present embodiment, the factors of the prediction error are decomposed into, and quantitatively calculated as an amount of contribution of an explanatory variable of the sample data, an amount of contribution of an objective variable of the sample data, and an amount of contribution of the prediction model. It should be noted that, as amounts of contribution, the information processing device 10 does not necessarily calculate all the amounts of contribution described above, but may calculate at least any one of them.

The information processing device 10 is configured by using one or more information processing devices each including an arithmetic unit and a storage device. Then, as illustrated in FIG. 2, the information processing device 10 includes a decomposition subject sample input unit 11, a decomposition result output unit 12, an error computation unit 13, an index computation unit 14, and an error decomposition unit 15. Respective functions of the decomposition subject sample input unit 11, the decomposition result output unit 12, the error computation unit 13, the index computation unit 14, and the error decomposition unit 15 can be realized by the arithmetic units executing programs that are stored on the storage devices, and are for realizing the respective functions. Further, the information processing device 10 includes a prediction model storage unit 16 and a reference data storage unit 17. The prediction model storage unit 16 and the reference data storage unit 17 are configured by using the storage devices. Hereinbelow, respective configuration is described in detail.

The prediction model storage unit 16 stores thereon data included in a prediction model f generated by machine learning in advance. For example, the prediction model f is a machine learning model generated by performing supervised learning, is generated by performing supervised learning using training data (X,Y) including sets of an explanatory variable X and an objective variable Y, and is configured to output a prediction value by receiving input of an unknown explanatory variable.

The reference data storage unit 17 has stored thereon reference data D that can be input to the prediction model f. The reference data D is data including sets (X,Y) of an explanatory variable X and an objective variable Y, is the training data described above used at the time of the learning of the prediction model f, verification data or evaluation data used at the time of evaluation of the prediction model f, operational-use data used at the time of operational use of the prediction model f, data of a type which is identical to the type of the training data, the operational-use data, or the like described above that can be input to the prediction model f, or the like, and is data that can be used for the prediction model f. Note that it is supposed in the present embodiment that the reference data D is the training data.

The decomposition subject sample input unit 11 receives input of sample data (subject data) which is a subject of decomposition of factors of a prediction error. The sample data is data including sets (x*,y*) of an explanatory variable x* and an objective variable y*, and may be data included in the reference data D described above, or may be data not included in the reference data D.

The decomposition result output unit 12 outputs amounts of contribution of respective pieces of data to a prediction error. For example, as described later, the decomposition result output unit 12 outputs an amount of contribution of an explanatory variable of the sample data, an amount of contribution of an objective variable of the sample data, and an amount of contribution of the prediction model that are calculated at the error decomposition unit 15, by causing a display device to display the amounts of contribution, and so on.

The error computation unit 13 (error calculation unit) calculates an prediction error that occurs when sample data (x*,y*) is input to the prediction model f. Specifically, the error computation unit 13 calculates a prediction error L*=L(y*,f(x*)) which is the difference between a prediction value f(x*) which is output obtained when an explanatory variable x* of the sample data is input to the prediction model f, and an objective variable y* of the sample data. For example, the prediction error can be represented by a squared error (y*−f(x*))² which is the square of the difference between the prediction value f(x*) and the objective variable y* of the sample data. It should be noted that the prediction error may be represented by any loss function such as a residual or 0-1 loss.

The index computation unit 14 (index calculation unit) calculates indices s* for evaluating the amounts of contribution of the respective pieces of data to the prediction error. Note that it is supposed that there are one or more indices which are represented by s*=(s*1, s*₂, . . . , s*M) (M≥1). It is supposed in the present embodiment that an index s*ₓ for an explanatory variable of the sample data, an index s*y for an objective variable of the sample data, and an index s*f for the prediction model are calculated as the indices s*. At this time, each index s* is calculated on the basis of data that can be used for calculating prediction errors including data that can be used for the prediction model f, such as the prediction model f, the reference data D, or the sample data (x*,y*). That is, since the prediction model f is used when a prediction error is calculated, each index s* can be calculated on the basis of data that was used for generation, evaluation, or operational use of the prediction model f or data that can be input to the prediction model f. Here, an example of the indices s* will be described with reference to FIG. 3. Note that the indices s* are calculated such that an increase of values thereof increases the prediction error.

First, as the index s*ₓ for an explanatory variable of the sample data, the abnormal degree of the explanatory variable x* of the sample data compared with the reference data can be used. For example, as the abnormal degree of the explanatory variable x* of the sample data, as illustrated in (3-1) of FIG. 3, the Mahalanobis distance of the explanatory variable x* of the sample data from the reference data D is used as the index s*ₓ. At this time, the index s*ₓ can be represented by the following Formula 1.

$${s}_{x}^{*} \sqrt{{( {x}^{*} - {μ}_{x} )}^{⊤} {\sum }_{x}^{- 1} ( {x}^{*} - {μ}_{x} )} \qquad [ Formula 1 ]$$

(The mean μₓ and the covariance matrix Ex are estimated from the reference data D.)

By calculating the index s*ₓ described above, as described later, a contribution of the abnormality of the explanatory variable x* of the sample data to the prediction error can be determined. Note that, as the index s*ₓ for an explanatory variable of the sample data, the value of the explanatory variable x* of the sample data may be used as it is, or another value may be used.

Further, as the index s*_{y} for an objective variable of the sample data, the abnormal degree of the objective variable y* of the sample data compared with the reference data can be used. For example, as the abnormal degree of the objective variable y* of the sample data, as illustrated in (3-2) of FIG. 3, the Mahalanobis distance of the objective variable y* of the sample data from the reference data D is used as the index s*_{y}. At this time, the index s*_{y} can be represented by the following Formula 2.

$${s}_{y}^{*} = \frac{\vert {y}^{*} - {μ}_{y} \vert}{{σ}_{y}} \qquad [ Formula 2 ]$$

(The mean μ_{y} and the variance matrix σ_{y} are estimated from the reference data D.)

By calculating the index s*ₓ described above, as described later, a contribution of the abnormality of the objective variable y* of the sample data to the prediction error can be determined.

Note that, as the index s*_{y} for an objective variable of the sample data, as illustrated in (3-3) of FIG. 3, the variance representing the degree of variation of an objective variable of reference data D related to the sample data, that is, reference data D positioned near the objective variable y* of the sample data, can be used. By using the variance as the index s*_{y} in this manner, it is possible to determine a contribution of difficulty of prediction by the prediction model to the prediction error. It should be noted that, as the index s*_{y} for an objective variable of the sample data, the value of the objective variable y* of the sample data may be used as it is, or another value may be used.

Further, as the index s*f for the prediction model, as illustrated in (3-4) of FIG. 3, a performance evaluation value of the prediction model using reference data D related to the sample data, that is, reference data D positioned near the sample data, can be used. At this time, as represented by the following Formula 3, the index s*_{f} can be represented by the mean squared error (MSE: Mean Squared Error) of the reference data D positioned near the sample data in relation to the prediction model f. Note that, in Formula 3, not the entire reference data D, but only the reference data D positioned near the sample data is used as the subject.

$${s}_{f}^{*} = \frac{\sum {( y - f ( x ) )}^{2}}{\vert 𝒟 \vert} \qquad [ Formula 3 ]$$

By using the performance evaluation value of the prediction model as the index s*_{f} in this manner, it is possible to determine a contribution of local performance of the prediction model to the prediction error. It should be noted that, as the index s*_{f} for the prediction model, another value may be used, and, for example, the mean precision of the prediction model may be calculated by using the entire reference data D as the subject.

By using the prediction error L* and the indices s* computed as described above, the error decomposition unit 15 (contribution calculation unit) calculates respective amounts of contribution L*ᵢ (i=x, y, f) of the explanatory variable x* of the sample data, the objective variable y* of the sample data, and the prediction model f to the prediction error L*. Here, the prediction error L* can be represented by the sum of the respective amounts of contribution corresponding to the respective indices, and can be represented by the following Formula 4, for example.

$${L}^{*} = {\sum }_{i} {L}_{i}^{*} + {L}_{0}^{*} \qquad [ Formula 4 ]$$

Here, L*₀ described above is a contribution of factors other than the computed indices (e.g. an offset or an unknown error), and can be equally distributed to the amounts of contribution corresponding to the respective indices. Because of this, in the present embodiment, the error decomposition unit 15 uses a contribution computation function that decomposes the prediction error L* to the respective amounts of contribution L*ᵢ at a ratio among the respective indices s*. For example, the contribution computation function is represented by the following Formula 5, and thereby can decompose the prediction error L* into the amounts of contribution L*ᵢ of the respective indices as in Formula 6.

$${L}_{i}^{*} = \frac{{s}_{i}^{*} {L}^{*}}{{s}_{x}^{*} + {s}_{y}^{*} + {s}_{f}^{*}} \qquad [ Formula 5 ]$$

$${L}^{*} = {L}_{x}^{*} + {L}_{y}^{*} + {L}_{f}^{*} \qquad [ Formula 6 ]$$

Note that the error decomposition unit 15 does not necessarily calculate the respective amounts of contribution corresponding to the respective indices by the method described above. For example, the error decomposition unit 15 may decompose the prediction error into the respective amounts of contribution by another method like the one described in a third exemplary embodiment described later.

### [Operation]

Next, an operation of the information processing device 10 described above will be described with reference to a flowchart in FIG. 4.

First, the information processing device 10 acquires the prediction model f generated by machine learning in advance, the reference data D that can be input to the prediction model f, and the sample data which is the subject of decomposition of a prediction error (step S1).

Next, the information processing device 10 calculates the prediction error L* that occurs when the sample data is input to the prediction model f (step S2). For example, the information processing device 10 calculates, as the prediction error L*, the squared error (y*−f(x*))² which is the square of the difference between the prediction value f(x*) which is output obtained when the explanatory variable x* of the sample data is input to the prediction model f and the objective variable y* of the sample data.

Further, the information processing device 10 calculates the indices s* for evaluating the amounts of contribution of the respective pieces of data to the prediction error (step S3). It is supposed in the present embodiment that the index s*ₓ for an explanatory variable of the sample data, the index s*_{y} for an objective variable of the sample data, and the index s*_{f} for the prediction model are calculated as the indices s*. For example, the abnormal degree of the explanatory variable x* of the sample data compared with the reference data, the abnormal degree of the objective variable y* of the sample data compared with the reference data, the variance representing the degree of variation of an objective variable of reference data D positioned near the objective variable y* of the sample data, the performance evaluation value of the prediction model using reference data D positioned near the sample data, and the like are used as the respective indices s*.

Then, by using the prediction error L* and the indices s* computed as described above, the information processing device 10 calculates the respective amounts of contribution L*ᵢ of the explanatory variable x* of the sample data, the objective variable y* of the sample data, and the prediction model f to the prediction error L* (step S4). In the present embodiment, the amounts of contribution L*ᵢ corresponding to the respective indices are calculated by using a contribution computation function that decomposes the prediction error L* to the respective amounts of contribution L*ᵢ at a ratio among the respective indices s*.

The information processing device 10 outputs the calculated amounts of contribution L*ᵢ corresponding to the respective indices by causing a display device to display them, and so on (step S5). For example, the amount of contribution of the explanatory variable of the sample data, the amount of contribution of the objective variable of the sample data, and the amount of contribution of the prediction model to the prediction error are output as illustrated in FIG. 1.

As described above, according to the present embodiment, the respective indices for evaluating the amounts of contribution of the respective pieces of data to prediction errors are calculated in advance on the basis of data that was used for calculating prediction errors of prediction errors including the data that was used for the prediction model f, and the amounts of contribution of the respective pieces of data to a prediction error are calculated on the basis of the respective indices. In particular, in the present embodiment, the index for an explanatory variable of the sample data, the index for an objective variable of the sample data, and the index for the prediction model are calculated, and the amounts of contribution to a prediction error are calculated as respective decomposed amounts of contribution. Thereby, factors of a prediction error by the prediction model can be evaluated quantitatively for each piece of data, and an appropriate measure for ameliorating the prediction model can be examined in accordance with the evaluation. As a result, it is possible to further improve the precision of the prediction model.

### Application Example

Here, as an application example of the present disclosure described above, an example in which the present disclosure is applied to the medicalcare/healthcare field is described. In this example, the prediction model is a model that predicts the number of patients to visit a hospital by receiving input of the day of the week, weather, data about neighboring hospitals, information about patients who visited in the past, and the like, and is used as the subject for which factors of a prediction error are decomposed in the information processing device 10 described above. By applying such a prediction model to the present disclosure, factors of a prediction error can be evaluated quantitatively for each piece of data, and an appropriate measure for ameliorating the prediction model can be examined in accordance with the evaluation. Then, by using the information processing device 10 of the present disclosure, decision-making by a staff in hospital management can be assisted.

### Second Exemplary Embodiment

Next, a second exemplary embodiment of the present disclosure is described. A main difference of the present embodiment from the first exemplary embodiment described above lies in the configuration of the index computation unit 14 and the error decomposition unit 15 in the information processing device 10. Hereinbelow, configuration different from that in the first exemplary embodiment described above is mainly described in detail.

The index computation unit 14 in the present embodiment generates the respective indices by using a check model g (second prediction model) which is another prediction model generated by using the prediction model f or the reference data D described above, and is different from the prediction model f. Here, the check model g is one or more models generated separately by machine learning for evaluating the performance of the prediction model f. Then, for example, the check model g is a model having learned a different hyperparameter using a learning algorithm which is the same as that for the prediction model f, a model having learned a dataset different from a dataset that was used for the learning by the prediction model f in a dataset included in the reference data D by using a learning algorithm which is the same as that for the prediction model f, or furthermore a model having learned the reference data D (the training data, etc.) by using a learning algorithm different from that for the prediction model f.

Then, the index computation unit 14 considers the check model g as the true model, and generates a plurality of indices s* by using output g(x*) obtained when the explanatory variable x* of the sample data is input to the check model g. Specifically, the index computation unit 14 computes the indices by using the variance V or the expected value E of output of m check models g as represented by Formula 7 calculated by using the check models g. For example, in the present embodiment, as represented by the following Formula 8, the index computation unit 14 calculates the index s*ₓ for the explanatory variable x* of the reference data, the index s*_{y} for an objective variable y* of the reference data, and the index s*f for the prediction model f, and also uses the respective indices s*x, s*_{y}, and s*_{f} as the amounts of contribution L*x, L*_{y}, and L*_{f} corresponding to the respective indices as they are. Note that L*₀ is an offset or another unknown error.

$${𝔼}_{g} [ g ( {x}^{*} ) ] = \frac{1}{m} {\sum }_{i = 1}^{m} {g}_{i} ( {x}^{*} ) \qquad [ Formula 7 ]$$

$${𝕍}_{g} [ g ( {x}^{*} ) ] = \frac{1}{m} {\sum }_{i = 1}^{m} {( {g}_{i} ( {x}^{*} ) - {𝔼}_{g} [ g ( {x}^{*} ) ] )}^{2}$$

$${L}_{x}^{*} = {s}_{x}^{*} = 2 {𝕍}_{g} [ g ( {x}^{*} ) ] \qquad [ Formula 8 ]$$

$${L}_{y}^{*} = {s}_{y}^{*} = {( {y}^{*} - {𝔼}_{g} [ g ( {x}^{*} ) ] )}^{2}$$

$${L}_{f}^{*} = {s}_{f}^{*} = {( f ( {x}^{*} ) - {𝔼}_{g} [ g ( {x}^{*} ) ] )}^{2}$$

$${L}_{0}^{*} = 2 {𝔼}_{g} [ ( {y}^{*} - g ( {x}^{*} ) ) ( g ( {x}^{*} ) - f ( {x}^{*} ) ) ]$$

As a contribution computation function, the error decomposition unit 15 sets an identity in which the sum of the respective indices s*ₓ, s*_{y}, and s*_{f} described above, that is, the respective amounts of contribution L*x, L*_{y}, and L*f, and the other amount of contribution L*₀, is equal to the prediction error L* of the prediction model f. For example, because an identity of the following Formula 9 holds true in a case where the prediction error L* is a squared error, a contribution computation function that uses the computed indices as they are as contributions to the error can be used. Then, by using the contribution computation function, the error decomposition unit 15 can calculate the respective amounts of contribution L*ₓ, L*_{y}, and L*f corresponding to the respective indices s*ₓ, s*_{y}, and s*f.

$${( {y}^{*} - f ( {x}^{*} ) )}^{2} = 2 {𝕍}_{g} [ g ( {x}^{*} ) ] + {( {y}^{*} - {𝔼}_{g} [ g ( {x}^{*} ) ] )}^{2} + {( f ( {x}^{*} ) - {𝔼}_{g} [ g ( {x}^{*} ) ] )}^{2} + 2 {𝔼}_{g} [ ( {y}^{*} - g ( {x}^{*} ) ) ( g ( {x}^{*} ) - f ( {x}^{*} ) ) ] \qquad [ Formula 9 ]$$

As described above, according to the present embodiment, the respective indices for evaluating the amounts of contribution of the respective pieces of data to prediction errors are set by using the check models g, and the amounts of contribution of the respective pieces of data to a prediction error are calculated on the basis of the respective indices. Thereby, factors of a prediction error by the prediction model can be evaluated quantitatively for each piece of data, and an appropriate measure for ameliorating the prediction model can be examined in accordance with the evaluation. As a result, it is possible to further improve the precision of the prediction model.

### Third Exemplary Embodiment

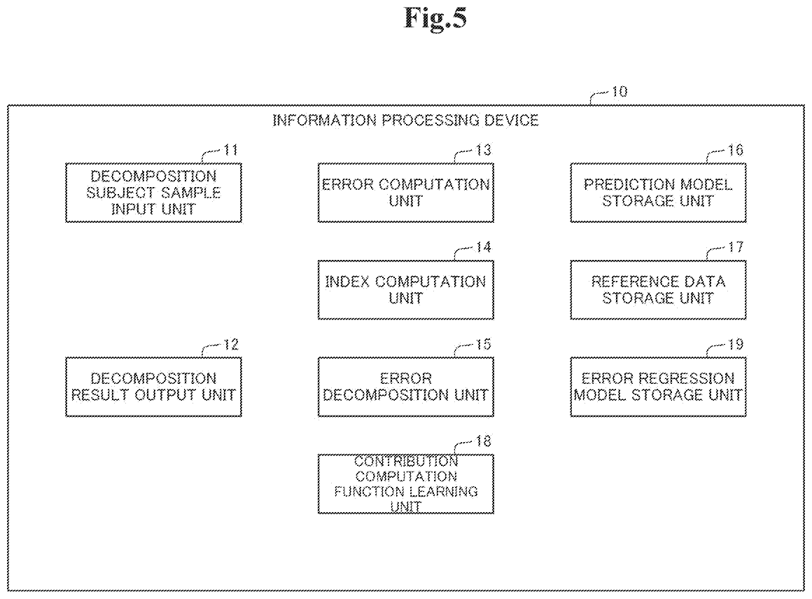

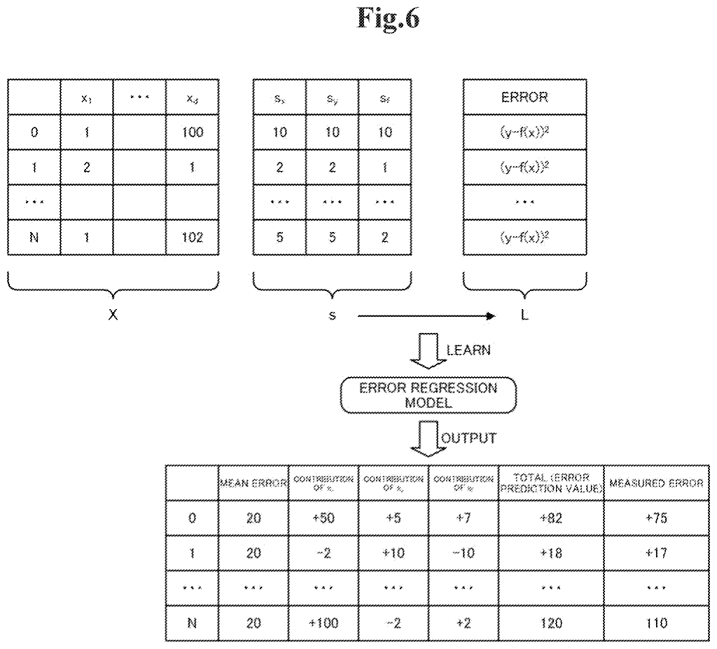

Next, a third exemplary embodiment of the present disclosure will be described with reference to FIGS. 5 to 6. FIG. 5 is a figure for describing the configuration of the information processing device 10, and FIG. 6 is a figure for describing a process performed by the information processing device 10.

In addition to the configuration of the information processing device 10 described with reference to the first exemplary embodiment and the second exemplary embodiment described above, as illustrated in FIG. 5, the information processing device 10 in the present embodiment includes a contribution computation function learning unit 18 and an error regression model storage unit 19. A function of the contribution computation function learning unit 18 can be realized by the arithmetic units executing programs that are stored on the storage devices, and are for realizing the respective functions. The error regression model storage unit 19 is configured by using a storage device. Hereinbelow, respective configuration is described in detail. Hereinbelow, configuration different from that in the first exemplary embodiment or the second exemplary embodiment described above is mainly described in detail.

The contribution computation function learning unit 18 (learning unit) generates an error regression model which is a machine learning model that has learned, by machine learning, the relationship between prediction errors of the prediction model and the indices described above, and predicts a prediction error from the indices. Specifically, first, as illustrated in FIG. 6, by using the prediction model f and the entire reference data D or part of the reference data D, a dataset of the indices s=(s₁, s₂, . . . ) (second indices) similar to those described above, and the error L which is a prediction error similar to the one described above obtained when the reference data is input to the prediction model f is prepared in advance by computation for each data point in the reference data. Note that the error L here is the error L which is the difference between the prediction value f(x) which is output obtained when the explanatory variable x of the reference data D such as the training data is input to the prediction model f and the objective variable y of the reference data D. Further, the indices s here are the indices s=(s₁, s₂, . . . ) for evaluating the amounts of contribution of the respective indices s₁ to the prediction error L, and are an index sₓ for the explanatory variable x computed for each point in the reference data D, an index s_{y} for the objective variable y computed for each point in the reference data D, and an index s_{f} for the prediction model computed for each point in the reference data D. For example, the calculation of the error L and the indices s is enabled by the function of the index computation unit 14 described above by using the prediction model f and the reference data D.

Then, the contribution computation function learning unit 18 learns, by machine learning, the indices s generated from the prediction model f and the reference data D as described above as an explanatory variable, and the error L as an objective variable, and generates an error regression model h(s). The contribution computation function learning unit 18 stores in advance the generated error regression model h(s) on the error regression model storage unit 19.

Note that the contribution computation function learning unit 18 may perform learning by selecting indices s by using a feature value selection approach, at the time of learning of the error regression model h(s) described above. For example, combinations of different indices s may be learned, and learning may be performed by selecting indices s such that the performance of the error regression model h(s) becomes better.

The error decomposition unit 15 (contribution calculation unit) in the present embodiment generates a contribution computation function by using the error regression model h(s) described above. For example, in a case where the error regression model h(s) is a linear model, the error decomposition unit 15 generates a contribution computation function by using weight parameters wᵢ set for the error regression model by learning. Specifically, a contribution computation function is generated such that the products of the respective weight parameters wᵢ given to the respective indices sₓ, s_{y}, and s_{f} in the error regression model, and the respective indices s*ₓ, s*_{y}, and s*_{f} calculated in the first exemplary embodiment as described above become the amounts of contribution L*₁ corresponding to the respective indices s*₁. For example, a contribution computation function as represented by the following Formula 10 is generated, and the prediction error L* described above can be used for decomposition into the amounts of contribution L*₁ corresponding to the respective indices, as represented by Formula 11.

$${L}_{i}^{*} = {w}_{i} {s}_{i}^{*} \qquad [ Formula 10 ]$$

$${L}^{*} = {L}_{0}^{*} + {\sum }_{i} {w}_{i} {s}_{i}^{*} \qquad [ Formula 11 ]$$

Further, in a case where the error regression model h(s) is not a linear model, the error decomposition unit 15 interprets output obtained when the respective indices s*ₓ, s*_{y}, and s*f calculated in the first exemplary embodiment as described above are input to the error regression model h(s) instead of the respective indices sₓ, s_{y}, and s_{f}, and generates a contribution computation function. In this case, for example, as represented by Formula 12, the degree of contribution of a contribution of each index can be calculated by using a model interpretation approach that can express output of the error regression model as the sum of contributions of the respective indices. For example, a contribution computation function as in the following Formula 13 is generated. Here, v*₁ is contributions of the respective indices, and, for example, are SHAP values (SHapley Additive exPlanations Values) of s*₁. Then, as represented by Formula 14, the prediction error L* described above can be used for decomposition into the amounts of contribution L*₁ corresponding to the respective indices.

$$h ( {s}^{*} ) = {v}_{0}^{*} + {\sum }_{i} {v}_{i}^{*} \qquad [ Formula 12 ]$$

$${L}_{i}^{*} = {v}_{i}^{*} \qquad [ Formula 13 ]$$

$${L}^{*} = {L}_{0}^{*} + {\sum }_{i} {v}_{i}^{*} \qquad [ Formula 14 ]$$

As described above, according to the present embodiment, a model having learned the relationship between indices and errors is generated, and, on the basis of the model, an amount of contribution of a feature value sᵢ to an error of each data point to the prediction error is calculated. Thereby, factors of a prediction error by the prediction model can be evaluated quantitatively for each piece of data, and an appropriate measure for ameliorating the prediction model can be examined in accordance with the evaluation. As a result, it is possible to further improve the precision of the prediction model.

### Fourth Exemplary Embodiment

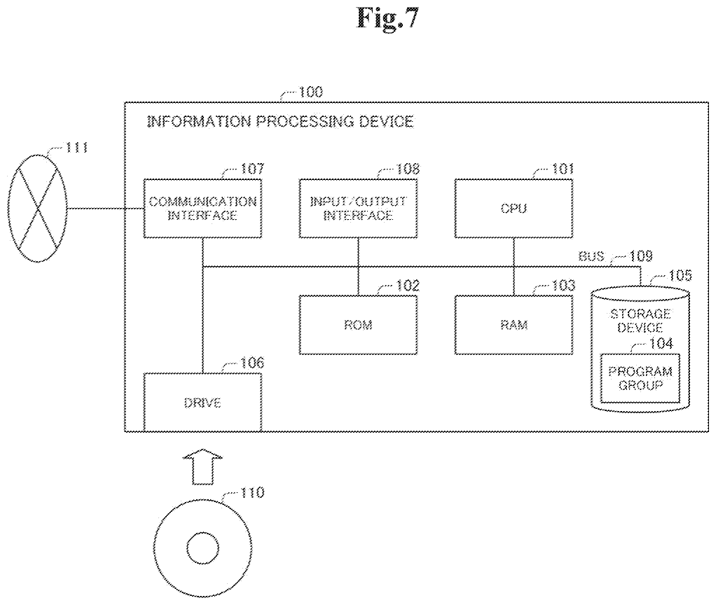

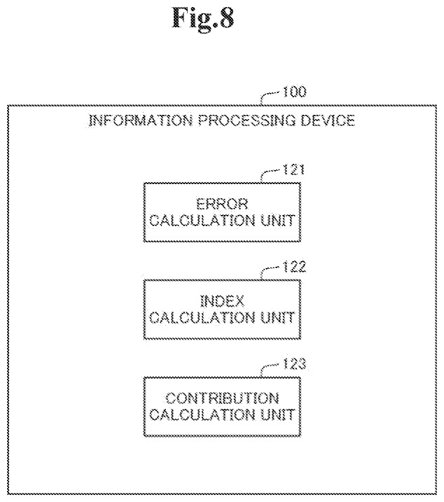

Next, a fourth exemplary embodiment of the present disclosure will be described with reference to FIG. 7 to FIG. 8. FIG. 7 and FIG. 8 are block diagrams illustrating the configuration of an information processing device according to the fourth exemplary embodiment. Note that the present embodiment illustrates the outline of the configuration of the information processing device described in the exemplary embodiments described above.

First, the hardware configuration of an information processing device 100 in the present embodiment will be described with reference to FIG. 7. The information processing device 100 is configured by using a typical information processing device, having hardware configuration as described below as an example.
Central Processing Unit (CPU) 101 (arithmetic unit)
Read Only Memory (ROM) 102 (storage device)
Random Access Memory (RAM) 103 (storage device)
Program group 104 to be loaded to the RAM 103
Storage device 105 storing thereon the program group 104
Drive 106 that performs reading and writing on a storage medium 110 outside the information processing device
Communication interface 107 connected to a communication network 111 outside the information processing device
Input/output interface 108 for performing input/output of data
Bus 109 connecting the respective constituent elements

Note that FIG. 7 illustrates an example of the hardware configuration of the information processing device that is the information processing device 100. The hardware configuration of the information processing device is not limited to that described above. For example, the information processing device may be configured by using part of the configuration described above, such as without the drive 106. Further, the information processing device can use, instead of the CPU described above, a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor or a microcontroller, a combination of these, or the like.

Then, the information processing device 100 can construct and be equipped with an error calculation unit 121, an index calculation unit 122, and a contribution calculation unit 123 illustrated in FIG. 8 through acquisition of the program group 104 and execution thereof by the CPU 101. Note that the program group 104 is stored on, for example, the storage device 105 or the ROM 102 in advance, is loaded to the RAM 103 by the CPU 101, and is executed by the CPU 101 as needed. Further, the program group 104 may be supplied to the CPU 101 via the communication network 111, or may be stored on the storage medium 110 in advance and read out by the drive 106 and supplied to the CPU 101. It should be noted that the error calculation unit 121, the index calculation unit 122, and the contribution calculation unit 123 described above may be constructed by electronic circuits dedicated for realizing the means.

The error calculation unit 121 described above calculates the prediction error which is the difference between the prediction value which is output obtained when an explanatory variable of the subject data is input to the prediction model and an objective variable of the subject data.

The index calculation unit 122 described above calculates an index for evaluating an amount of contribution, to the prediction error, of at least one of the explanatory variable of the subject data, the objective variable of the subject data, and the prediction model, on the basis of data that was used for calculating the prediction error. For example, the index calculation unit 122 calculates the index by using at least one piece of data of the explanatory variable of the subject data, the objective variable of the subject data, and the prediction model, and reference data that was used when the prediction model was generated.

The contribution calculation unit 123 described above calculates the amount of contribution on the basis of the prediction error and the index.

With the configuration described above, the present disclosure can evaluate factors of a prediction error by the prediction model quantitatively, and can examine an appropriate measure for ameliorating the prediction model in accordance with the evaluation. As a result, it is possible to further improve the precision of the prediction model.

Note that the program described above can be supplied to a computer by being stored on a non-transitory computer readable medium of any type. Non-transitory computer readable media include tangible recording media of various types. Examples of non-transitory computer readable media include a magnetic recording medium (e.g. flexible disk, magnetic tape, hard disk drive), a magneto-optical recording medium (e.g. magneto-optical disk), a CD-ROM (Read Only Memory), a CD-R, a CD-R/W, and a semiconductor memory (e.g. mask ROM, PROM (Programmable ROM), EPROM (Erasable PROM), flash ROM, and RAM (Random Access Memory)). Further, the program may also be supplied to a computer by being stored on a transitory computer readable medium of any type. Examples of transitory computer readable media include electric signals, optical signals, and electromagnetic waves. A transitory computer readable medium can supply programs to a computer via a wired communication channel such as an electric wire and an optical fiber, or a wireless communication channel.

While the present disclosure has been described thus far with reference to the exemplary embodiments and the like described above, the present disclosure is not limited to the exemplary embodiments described above. The configuration and details of the present disclosure can be changed within the scope of the present disclosure in various manners that can be understood by those skilled in the art. Further, at least one or more functions of the functions of the error calculation unit 121, the index calculation unit 122, and the contribution calculation unit 123 described above may be executed by an information processing device provided and connected at any location on a network, that is, may be executed by so-called cloud computing.

### <Supplementary Notes>

The whole or part of the exemplary embodiments described above can be described as, but not limited to, the following supplementary notes. Hereinbelow, the outline of the configuration of an information processing device, an information processing method, and a program according to the present disclosure will be described. It should be noted that the present disclosure is not limited to the following configuration.

### (Supplementary Note 1)

An information processing device comprising:
an error calculation unit that calculates a prediction error which is a difference between a prediction value which is output obtained when an explanatory variable of subject data is input to a prediction model and an objective variable of the subject data;
an index calculation unit that calculates, on a basis of data that can be used for calculating the prediction error, an index for evaluating an amount of contribution of at least one of the explanatory variable of the subject data, the objective variable of the subject data, and the prediction model to the prediction error; and
a contribution calculation unit that calculates the amount of contribution on a basis of the prediction error and the index.

### (Supplementary Note 2)

The information processing device according to supplementary note 1, wherein
the index calculation unit calculates the index by using at least one piece of data of the explanatory variable of the subject data, the objective variable of the subject data, and the prediction model, and reference data used for the prediction model.

### (Supplementary Note 3)

The information processing device according to supplementary note 2, wherein
the index calculation unit calculates the index for at least one of the explanatory variable and the objective variable of the subject data by using the subject data and the reference data.

### (Supplementary Note 4)

The information processing device according to supplementary note 3, wherein
the index calculation unit calculates the index for at least one of the explanatory variable and the objective variable of the subject data on a basis of a result of comparison between the subject data and the reference data.

### (Supplementary Note 5)

The information processing device according to supplementary note 3, wherein
the index calculation unit calculates the index for the objective variable of the subject data on a basis of a degree of variation of the objective variable of the reference data related to the subject data.

### (Supplementary Note 6)

The information processing device according to any of supplementary notes 2 to 5, wherein
the index calculation unit calculates the index for the prediction model on a basis of a performance evaluation value of the prediction model calculated by using the reference data related to the subject data.

### (Supplementary Note 7)

The information processing device according to any of supplementary notes 1 to 6, wherein
the index calculation unit generates the index on a basis of the subject data and a second prediction model generated on a basis of at least the prediction model or reference data used for the prediction model.

### (Supplementary Note 8)

The information processing device according to supplementary note 7, wherein
the index calculation unit calculates a plurality of the indices on a basis of output obtained by inputting an explanatory variable of the subject data to the second prediction model, and
the contribution calculation unit calculates the amounts of contribution on a basis of values of the indices that give a sum of a plurality of the indices which is equal to a value based on the prediction error.

### (Supplementary Note 9)

The information processing device according to supplementary note 8, wherein
the index calculation unit calculates, on a basis of output obtained by inputting an explanatory variable of the subject data to the second prediction model, the index at least for each of the explanatory variable of the subject data, the objective variable of the subject data, and the prediction model, and
the contribution calculation unit calculates the contributions on a basis of values of the indices that satisfy an identity between a value including at least a sum of all of the indices and a value based on the prediction error.

### (Supplementary Note 10)

The information processing device according to any of supplementary notes 1 to 9, further comprising a learning unit that performs machine learning of a model representing a relationship between an error which is a difference between output obtained when an explanatory variable of reference data used for the prediction model is input to the prediction model and an objective variable of the reference data, and a second index for evaluating an amount of contribution, to the error, of each of the explanatory variable of the reference data, the objective variable of the reference data, and the prediction model, wherein the contribution calculation unit calculates the amount of contribution on a basis of the model, the index, and the prediction error.

### (Supplementary Note 11)

The information processing device according to supplementary note 10, wherein the contribution calculation unit calculates the amounts of contribution on a basis of a degree of contribution of the index to output obtained when the index is input to the model.

### (Supplementary Note 12)

The information processing device according to supplementary note 10 or 11, wherein the learning unit selects the second index, and performs machine learning of the model.

### (Supplementary Note 13)

An information processing method comprising:
calculating a prediction error which is a difference between a prediction value which is output obtained when an explanatory variable of subject data is input to a prediction model and an objective variable of the subject data;
calculating, on a basis of data that can be used for calculating the prediction error, an index for evaluating an amount of contribution of at least one of the explanatory variable of the subject data, the objective variable of the subject data, and the prediction model to the prediction error; and
calculating the amount of contribution on a basis of the prediction error and the index.

### (Supplementary Note 14)

The information processing method according to supplementary note 13, wherein
the index is generated on a basis of the subject data and a second prediction model generated on a basis of at least the prediction model or the reference data used for the prediction model.

### (Supplementary Note 15)

The information processing method according to supplementary note 13 or 14, wherein
machine learning of a model is performed, the model representing a relationship between an error which is a difference between output obtained when an explanatory variable of the reference data is generated is input to the prediction model and an objective variable of the reference data, and a second index for evaluating a contribution, to the error, of each of the explanatory variable of the reference data, the objective variable of the reference data, and the prediction model, and
the contribution is calculated on a basis of the model, the index, and the prediction error.

### (Supplementary Note 16)

A computer readable storage medium having stored thereon a program that causes a computer to execute processes of:
calculating a prediction error which is a difference between a prediction value which is output obtained when an explanatory variable of subject data is input to a prediction model and an objective variable of the subject data;
calculating, on a basis of data that can be used for calculating the prediction error, an index for evaluating an amount of contribution of at least one of the explanatory variable of the subject data, the objective variable of the subject data, and the prediction model to the prediction error; and
calculating the amount of contribution on a basis of the prediction error and the index.

### REFERENCE SIGNS LIST

10 information processing device
11 decomposition subject sample input unit
12 decomposition result output unit
13 error decomposition unit
14 index computation unit
15 error decomposition unit
16 prediction model storage unit
17 reference data storage unit
18 contribution computation function learning unit
19 error regression model storage unit
100 information processing device
101 CPU
102 ROM
103 RAM
104 program group
105 storage device
106 drive
107 communication interface
108 input/output interface
109 bus
110 storage medium
111 communication network
121 error calculation unit
122 index calculation unit
123 contribution calculation unit

What is claimed is:

1. An information processing device comprising:
at least one memory configured to store instructions; and
at least one processor configured to execute instructions to:
calculate a prediction error which is a difference between a prediction value which is output obtained when an explanatory variable of subject data is input to a prediction model and an objective variable of the subject data;
calculate, on a basis of data that can be used for calculating the prediction error, an index for evaluating an amount of contribution of at least one of the explanatory variable of the subject data, the objective variable of the subject data, and the prediction model to the prediction error; and
calculate the amount of contribution on a basis of the prediction error and the index.

2. The information processing device according to claim 1, wherein
the at least one processor is configured to execute the instructions to calculate the index by using at least one piece of data of the explanatory variable of the subject data, the objective variable of the subject data, and the prediction model, and reference data used for the prediction model.

3. The information processing device according to claim 2, wherein
the at least one processor is configured to execute the instructions to calculate the index for at least one of the explanatory variable and the objective variable of the subject data by using the subject data and the reference data.

4. The information processing device according to claim 3, wherein
the at least one processor is configured to execute the instructions to calculate the index for at least one of the explanatory variable and the objective variable of the subject data on a basis of a result of comparison between the subject data and the reference data.

5. The information processing device according to claim 3, wherein
the at least one processor is configured to execute the instructions to calculate the index for the objective variable of the subject data on a basis of a degree of variation of the objective variable of the reference data related to the subject data.

6. The information processing device according to claim 2, wherein
the at least one processor is configured to execute the instructions to calculate the index for the prediction model on a basis of a performance evaluation value of the prediction model calculated by using the reference data related to the subject data.

7. The information processing device according to claim 1, wherein
the at least one processor is configured to execute the instructions to generate the index on a basis of the subject data and a second prediction model generated on a basis of at least the prediction model or reference data used for the prediction model.

8. The information processing device according to claim 7, wherein
the at least one processor is configured to execute the instructions to:
calculate a plurality of the indices on a basis of output obtained by inputting an explanatory variable of the subject data to the second prediction model, and
calculate the amounts of contribution on a basis of values of the indices that give a sum of a plurality of the indices which is equal to a value based on the prediction error.

9. The information processing device according to claim 8, wherein
the at least one processor is configured to execute the instructions to:
calculate, on a basis of output obtained by inputting an explanatory variable of the subject data to the second prediction model, the index at least for each of the explanatory variable of the subject data, the objective variable of the subject data, and the prediction model, and
calculate the amounts of contribution on a basis of values of the indices that satisfy an identity between a value including at least a sum of all of the indices and a value based on the prediction error.

10. The information processing device according to claim 1, wherein
the at least one processor is configured to execute the instructions to:
perform machine learning of a model representing a relationship between an error which is a difference between output obtained when an explanatory variable of reference data used for the prediction model is input to the prediction model and an objective variable of the reference data, and a second index for evaluating an amount of contribution, to the error, of each of the explanatory variable of the reference data, the objective variable of the reference data, and the prediction model, and
calculate the amount of contribution on a basis of the model, the index, and the prediction error.

11. The information processing device according to claim 10, wherein
the at least one processor is configured to execute the instructions to calculate the amounts of contribution on a basis of a degree of contribution of the index to output obtained when the index is input to the model.

12. The information processing device according to claim 10, wherein
the at least one processor is configured to execute the instructions to select the second index, and perform machine learning of the model.

13. An information processing method comprising:
calculating a prediction error which is a difference between a prediction value which is output obtained when an explanatory variable of subject data is input to a prediction model and an objective variable of the subject data;
calculating, on a basis of data that can be used for calculating the prediction error, an index for evaluating an amount of contribution of at least one of the explanatory variable of the subject data, the objective variable of the subject data, and the prediction model to the prediction error; and
calculating the amount of contribution on a basis of the prediction error and the index.

14. The information processing method according to claim 13, wherein
the index is generated on a basis of the subject data and a second prediction model generated on a basis of at least the prediction model or reference data used for the prediction model.

15. The information processing method according to claim 13, wherein
machine learning of a model is performed, the model representing a relationship between an error which is a difference between output obtained when an explanatory variable of reference data used when the prediction model is generated is input to the prediction model and an objective variable of the reference data, and a second index for evaluating a contribution, to the error, of each of the explanatory variable of the reference data, the objective variable of the reference data, and the prediction model, and
the contribution is calculated on a basis of the model, the index, and the prediction error.

16. A non-transitory computer readable storage medium having stored thereon a program that causes a computer to execute processes of:
calculating a prediction error which is a difference between a prediction value which is output obtained when an explanatory variable of subject data is input to a prediction model and an objective variable of the subject data;
calculating, on a basis of data that can be used for calculating the prediction error, an index for evaluating an amount of contribution of at least one of the explanatory variable of the subject data, the objective variable of the subject data, and the prediction model to the prediction error; and
calculating the amount of contribution on a basis of the prediction error and the index.
